(19) United States
(12) Patent Application Publication
(10) Pub. No.: US 2011/0231218 A1
(43) Pub. Date: Sep. 22, 2011

(54) Systems and Methods for Providing Reminders for a Task List

(76) Inventor: Tom C. Tovar, San Francisco, CA (US)

(21) Appl. No.: 12/897,639

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06Q 10/00

(52) U.S. Cl. 705/7.15

(57) ABSTRACT

Systems and methods for providing reminders in a user-created task list are described. At least a portion of a user-created task list is received from an Internet service via a user interface between an end user and the Internet service. The user-created task list includes one or more tasks organized into one or more categories. An intermediary display is generated, wherein the intermediary display includes a first subset of the one or more tasks, and the generated intermediary display is transmitted via the user interface to the end user.

### CROSS REFERENCES TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to online task lists shared at a household or network level. The invention relates more particularly to systems and methods for providing reminders in a user-created task list.

### SUMMARY OF THE INVENTION

Various embodiments of systems and methods for providing reminders in a user-created task list are described. An exemplary method for providing reminders in the user-created task list may include several steps. At least a portion of a user-created task list may be received from an Internet service via a user interface between an end user and the Internet service. The user-created task list includes one or more tasks organized into one or more categories. An intermediary display is generated, wherein the intermediary display includes a first subset of the one or more tasks, and the generated intermediary display may be transmitted via the user interface to the end user.

An exemplary system for providing reminders in a user-created task list may include a user interface between an end user and an Internet service that receives at least a portion of the user-created task list, where the user-created task list includes one or more tasks organized into one or more categories and the Internet service stores the user-created task list. The exemplary system may also include a processor for executing instructions stored in memory to generate an intermediary display that includes a first subset of the one or more tasks and transmit the generated intermediary display via the user interface to the end user.

### BRIEF DESCRIPTION OF THE DRAWINGS

FIG. 1 is a flow chart of an exemplary method for providing reminders in a user-created task list in accordance with various embodiments of the present invention.

FIG. 2 is a block diagram of an exemplary environment for providing reminders in a user-created task list in accordance with various embodiments of the present invention.

FIG. 3 is an exemplary screenshot in a user-created task list application in accordance with various embodiments of the present invention.

FIG. 4 is an exemplary screenshot showing a reminder user interface associated with a user-created task list application in accordance with various embodiments of the present invention.

FIG. 5 is an exemplary screenshot showing a configuration user interface associated with a user-created task list application in accordance with various embodiments of the present invention.

FIG. 6 is an exemplary screenshot showing a confirmation user interface associated with a user-created task list application in accordance with various embodiments of the present invention.

FIG. 7 is an exemplary screenshot showing an intermediary display user interface associated with a user-created task list application in accordance with various embodiments of the present invention.

FIG. 8 is a block diagram of a DNS network arrangement in accordance with various embodiments of the present invention.

FIG. 9 is a block diagram of an exemplary system for providing reminders in a user-created task list in accordance with various embodiments of the present invention.

FIG. 10 is a block diagram of an exemplary system for providing reminders in a user-created task list in accordance with various embodiments of the present invention.

### DETAILED DESCRIPTION

Various embodiments of the present invention provide a method and system for providing reminders in a user-created task list. One or more end users may wish to collaborate on a user-created task list and receive reminders online regarding tasks on the task list. An exemplary system for providing reminders in a user-created task list may include an Internet service that may be coupled to an Internet service provider. The Internet service may store the user-created task list. The system may also include a user interface between an end user and the Internet service that receives at least a portion of the user-created task list, which includes one or more tasks organized into one or more categories. The exemplary system may also include a processor for executing instructions stored in memory to generate an intermediary display that includes a first subset of the one or more tasks and transmit the generated intermediary display via the user interface to the end user.

Generally speaking, an administrator may create and enforce task list polices for one or more end users that utilize computing devices coupled to an Internet service delivered to a location such as a home, residence or place of business or campus. The term “administrator” may include not only individuals, such as parents, but also any individual creating task list policies regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have an app. As used herein, an app shall be defined as a module including a user interface to an Internet service. The app may further include one or modules included in the Internet service. An app may be downloaded and installed on a user's computing device, including mobile devices. Users may define a task list policy via a user device, such as through the user interface. Some embodiments of the present invention do not require software to be downloaded or installed locally to the user device and, accordingly, do not require the user to execute a de-install application to cease use of the system.

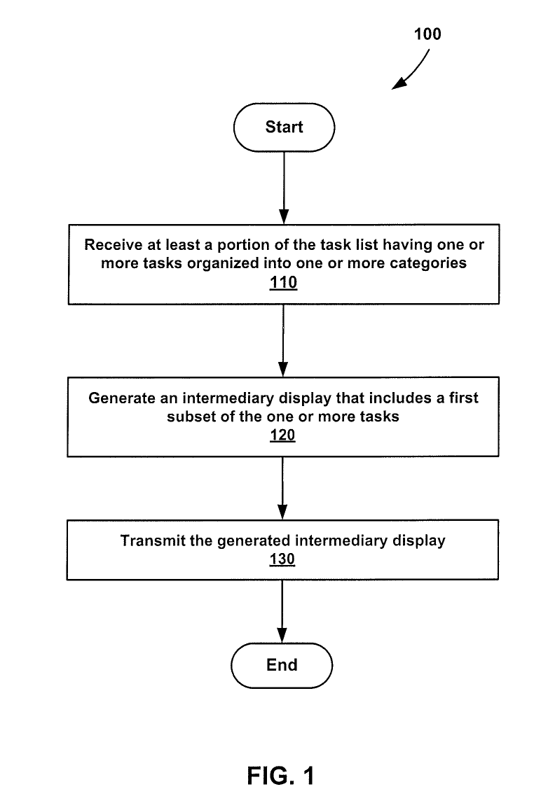

FIG. 1 is a flow chart of an exemplary method 100 for providing reminders in a user-created task list. The user who creates the task list may be an administrator or an end user. Multiple users may have input to the contents of the task list. At step 110 of the method 100, at least a portion of the user-created task list is received from an Internet service via a user interface between an end user and the Internet service. The user-created task list may be a list that includes one or more tasks organized into one or more categories. The one or more categories may be selected from a predetermined array of categories and/or customized by an end user. The customization may take the form of modifying an existing category (e.g., to better describe a category in the context of the end user's application), or may be implemented by having the end user input an entirely new category. In an exemplary embodiment, the one or more categories may be predetermined to include a shopping category, an activities category, a household chores category, a gift wish category and a miscellaneous category. Each task may be associated with one or more categories so that the end user may view the user-created task list and have each task grouped together in a display by category. Within the user-created task list, or within a category thereof, the one or more tasks may be organized in any suitable order, including in chronological order in an exemplary embodiment, or by a priority value that may be assigned to the one or more tasks by the end user.

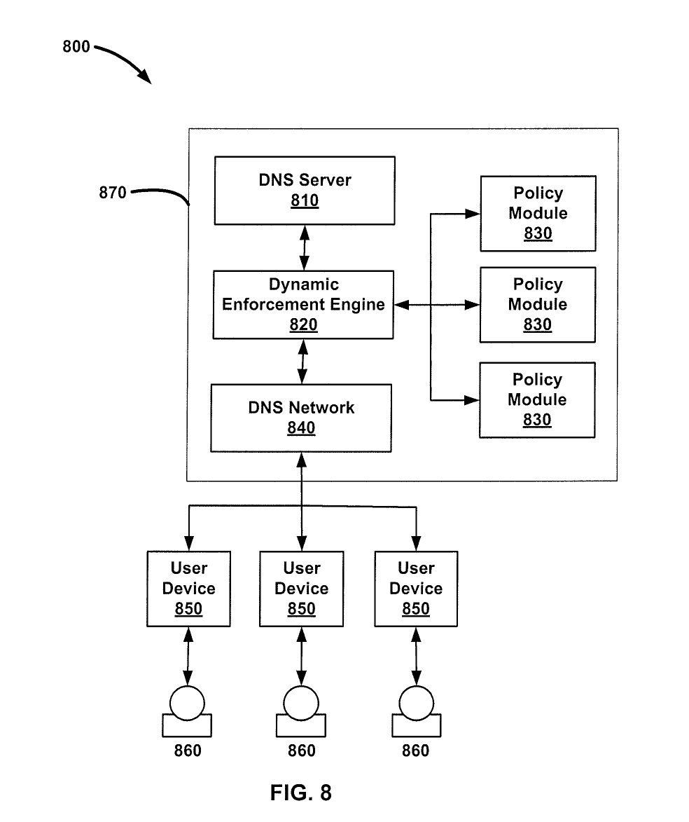

The Internet service may be provided by an Internet service provider, for example, and the Internet service, which may utilize a DNS resolver (such as the DNS resolver 810 of FIG. 8). Also, the user interface may be accessible by one or more user devices operated by the end user, such as a personal computing device, a mobile electronic device, or other electronic device with access to the Internet. The user interface may operate between any end user and the Internet service. User devices (such as user devices 850 of FIG. 8) may comprise various computing devices. If remote control of the method is desired, a portable computing device such as a Smartphone may be utilized as the control device. In this scenario, operating applications may reside on the user device 850.

At step 120, an intermediary display is generated by the task policy, wherein the intermediary display comprises a first subset of the one or more tasks. The first subset of the tasks may include the same tasks as the user-created task list, or a smaller set of the one or more tasks. Furthermore, the portion of the user-created task list received may be customized to include any portion desired by an end user, and may include, for example, all the tasks apportioned to a particular end user (e.g., a particular member of the family), or the tasks apportioned to all of the end users in a certain time frame (e.g., the tasks to be done that morning, day, or week).

The format of the intermediary display may be determined during step 120. The intermediary display, as described below, may take the form of a web page, a pop-up window, an overlay, a message, or a substantially unobtrusive tab or icon that appears on the display of the user device. In various embodiments of the present technology, the generated intermediary display may include the date and/or time that a task was set, as well as a description of the task. It may be appreciated that any engine, module, server, database, or any combination thereof may be used to generate the intermediary display.

The generated intermediary display is transmitted at step 130 via the user interface to the end user. In some embodiments, the intermediary display is transmitted to display on a user device of the end user via the user interface. In further embodiments, the intermediary display is transmitted to display on a web browser window or tab.

As described below in greater detail, in some exemplary embodiments, the generated intermediary display may be transmitted when a predetermined event occurs, such as when the user device is turned on or when the user accesses the internet as detected by the user interface. According to various embodiments, the generated intermediary display may be transmitted when the end user accesses an end user home page. The end user home page may be extracted from a stored browser setting file, which may advantageously facilitate use of a user-created task list application by users with less experience with software applications.

The home page access may be used to establish the start of a session interval. An administrator may choose to not display the intermediary display multiple times during a single end user session. The administrator may not want to again display the intermediary page if the end user simply leaves a user device for a brief period. Tracking the session interval may ensure that the end user is presented with the intermediary page only once per session.

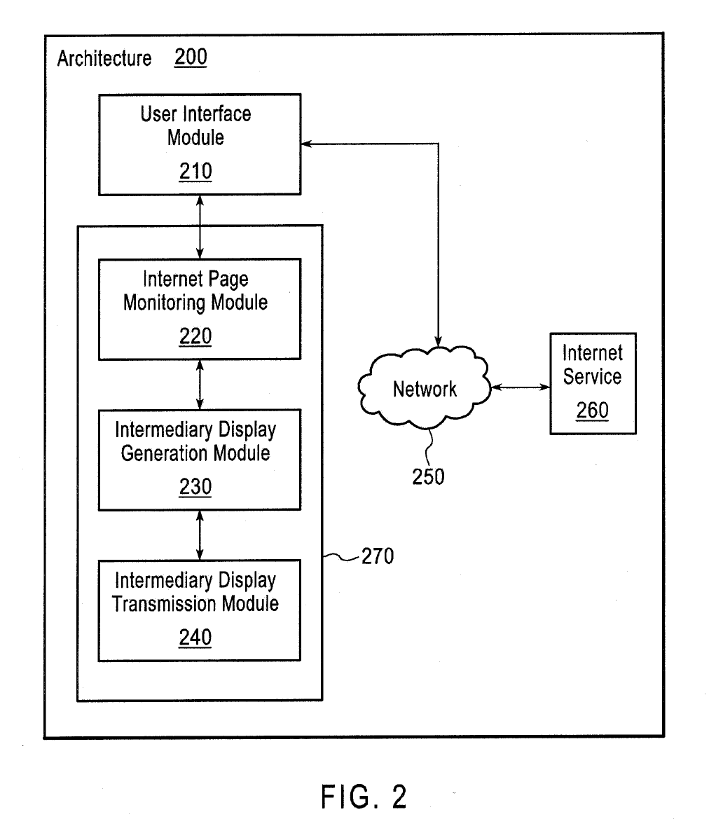

FIG. 2 illustrates an exemplary architecture 200 of a system for a user-created task list application. The exemplary architecture 200 includes a user interface module 210, an Internet page monitoring module 220, an intermediary display generation module 230, an intermediary display transmission module 240, a network 250, and an Internet service 260. Alternative embodiments may comprise more, less, or functionally equivalent modules. Although various modules may be configured to perform some or all of the various steps described herein, fewer or more modules may be provided and still fall within the scope of various embodiments

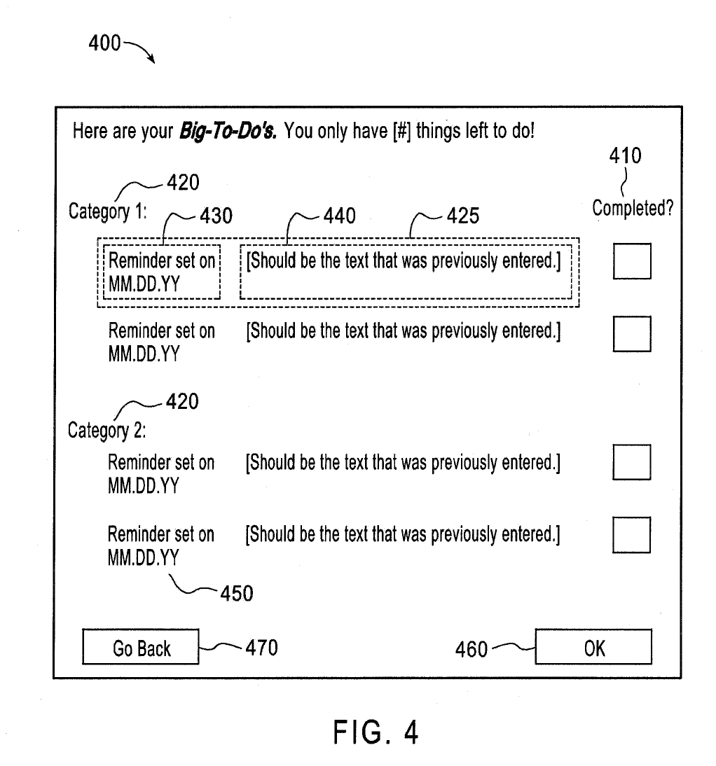

The user interface module 210 provides one or more user interfaces to the end user as a result of the user-created task list application. The user interface module 210 provides a user interface between the end user and the Internet service 260, so that communications between the two are enabled. Exemplary user interfaces provided by the user interface module 210 are shown in FIGS. 4, 5, 6, and 7.

The Internet page monitoring module 220 may perform a step of determining whether the Internet has been accessed or whether an Internet home page has been visited by the end user. If the Internet has been accessed or an Internet home page has been visited by the end user, the event may trigger the user-created task list application to provide a reminder in the form of an intermediary display. The intermediary display generation module 230 may perform a steps of receiving the user-created task list (such as the step 110 of the method 100 described earlier herein in relation to FIG. 1) and generating an intermediary display (such as the step 120 of the method 100 described earlier herein in relation to FIG. 1). The intermediary display transmission module 240 may perform a step of transmitting the intermediary display to the end user (such as the step 130 of the method 100 described earlier herein in relation to FIG. 1). Modules 220, 230, and 240 may be considered to constitute an Internet mediation system 270.

The architecture 200 includes a network 250 which may comprise a DNS resolver. The network 250 may also include any type and number of databases, servers, end users, computing devices, and policy engines. The task list may be stored and/or amended using the Internet service 260. It will be appreciated by one skilled in the art that the system in FIG. 2 may be merged with or used in conjunction with any of the other exemplary systems described herein, including but not limited to the systems shown in FIGS. 8, 9 and 10.

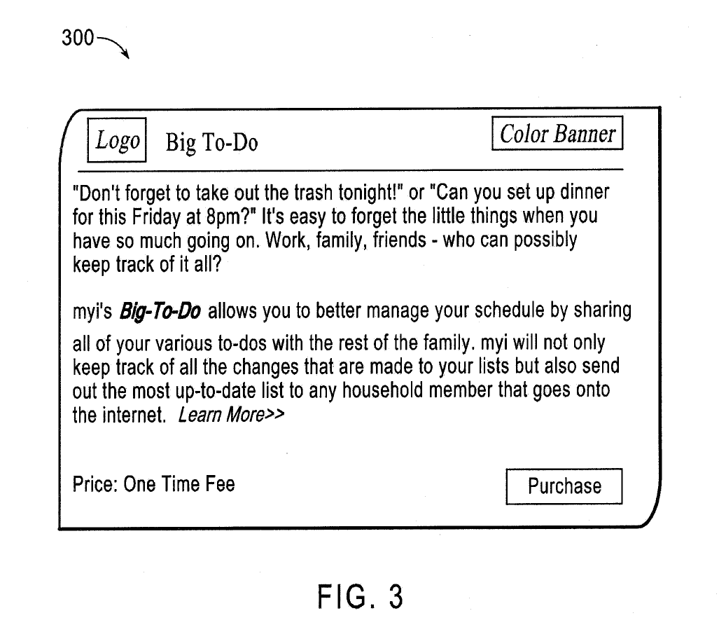

FIG. 3 is an exemplary screenshot of a user interface 300 that may be presented to an end user. The exemplary screenshot 300 provides a written summary of a user-created task list application. Such a user-created task list application may implement one or more methods described herein. The end user may click or otherwise actuate a “Learn More” link which will provide more information about the user-created task list application beyond the initial summary provided to the end user. The end user may purchase a copy of the user-created task list application by clicking or otherwise actuating the “Purchase” button. Following the purchase of the user-created task list application, the end user may be provided an opportunity to download the user-created task list application onto their user device.

FIG. 4 is an exemplary screenshot showing a reminder user interface 400 associated with a user-created task list application. The reminder user interface 400 may be displayed to an end user as part of a user-created task list application, for example, as the intermediary display. As shown in FIG. 4, the reminder user interface 400 may include a task completion column 410, categories 420, a task 425 associated with a first category, a task 450 associated with a second category, an OK button 460, and a Go Back button 470. Each task 425 and 450 may be associated with an assignment date 430 corresponding to the date and time by which the task 425 needs to be completed and a written description 440 describing the nature of the task (e.g., to purchase a particular item or perform a household chore).

Please note that although FIG. 4 shows two categories, FIG. 4 is exemplary only. Thus, one skilled in the art may appreciate that a reminder user interface 400 may include only one category with one or more tasks or it may include a plurality of categories with one or more tasks associated with each category.

In some embodiments, the end user may indicate on the intermediary display that a task has been completed. In the exemplary embodiment shown in FIG. 4, a completion input may be received to selectively amend the user-created task list by indicating that a second set of the one or more tasks has been completed by the end user. According to various embodiments, the second set of the one or more tasks may be a subset of the first subset of the one or more tasks. The completion input may be any input or combination of inputs that is detectable by the reminder user interface 400 and that identifies one or more of the tasks displayed on the reminder user interface 400 as being completed. For example, the completion input may include one or more marking inputs indicating the completed tasks and an authorization input that saves the changes in the user-created task list. The end user may provide the marking input associated with each task within the second set of the one or more tasks by checking or otherwise selecting a box or button in the completion column 410 adjacent to the completed task. The end user may then further amend the user-created task list by providing an authorization input, which can take the form of selecting the OK button 460 for example. Thus, according to some exemplary embodiments, when the end user modifies the user-created task list to indicate some tasks have been completed, the end user may select the OK button 460 to trigger a transmission of the most current version of the user-created task lists to the one or more end users of the system. Also, if the end user wishes to view a configuration user interface to modify the user-created task list (as described below), the end user may select the Go Back button 470 to exit the reminder user interface 400.

Variations of the intermediary display may be utilized in addition to the embodiment displayed in FIG. 4. For example, the transmitted intermediary display may further include a description of a set of one or more tasks, the tasks having been completed before transmission of the intermediary display. The description of the completed tasks may include the time and/or date the task was completed, the identity of the end user who completed the task and/or a written description of the task completed, for example. Displaying completed tasks in a reminder may be advantageous to end users by allowing the end users to see that tasks of interest have been completed, and also may help coordinate end users to prevent unnecessary duplication of completed tasks.

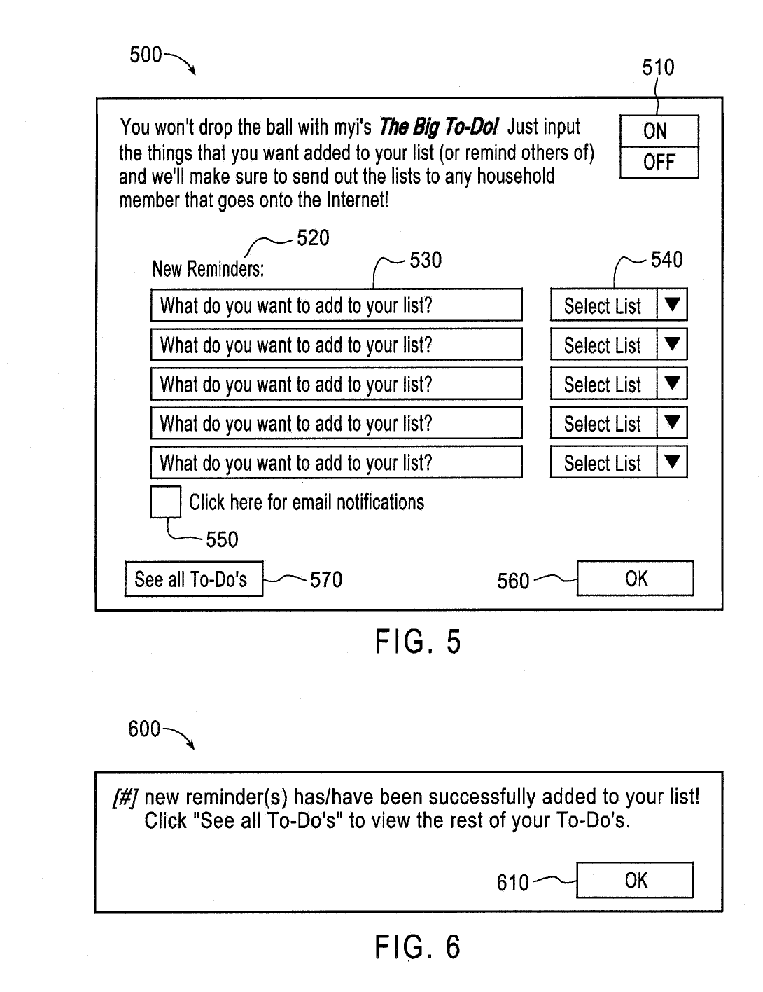

FIG. 5 is an exemplary screenshot of a configuration user interface 500 associated with a user-created task list application. The configuration user interface 500 may be displayed to an end user as part of a user-created task list application. The configuration user interface 500 may be a configuration drawer for the user-created task list application. According to various embodiments, the end user may utilize the configuration user interface 500 to set configurations of the user-created task list application. An optional summary of the user-created task list application may be provided in the exemplary user interface 500. As shown in FIG. 5, the configuration user interface 500 may include an On/Off button set 510 and a new task list 520, which may be populated by additional tasks 530 and a category field 540 corresponding to each additional task 530. The user interface 500 may also include an email notification button 550, an OK button 560, and a full task list button 570.

One or more additional tasks, wherein each additional task 530 is associated with a category 540, may be input by the end user using the configuration user interface 500. The additional tasks 530 may be added to the user-created task list to form a modified task list. In an exemplary embodiment, each additional task 530 may be associated with a description that includes information about the task, such as a deadline time and/or date and a written explanation of what the task entails. The category 540 may be any of the categories described above, and may also be customized by the end user to include any suitable category title (e.g., by providing a text prompt that the end user may type in the desired category name). The category 540 may also be preloaded or otherwise stored as part of the user-created task list application, so the end user may select from a preloaded list using a drop-down menu or other suitable interface.

Any suitable presentation may be used for additional tasks. For instance, as depicted in FIG. 5, the additional task 530 and the category field 540 listed in a given row may be associated with one another. However, it will be appreciated by those skilled in the art that any number of configurations showing the associations of an additional task 530 and the category field 540 may be depicted in the user interface 500. End users may repeat the process of providing additional tasks 530 and associated categories 540. Once all the entries have been received, the end user may click on or otherwise actuate the OK button 560 to add the additional tasks 530 to the user-created task list. In some embodiments, selecting the OK button 560 acts as a confirmation input that may make the modified task list accessible by one or more additional end users. Once the OK button 560 has been selected, the configuration user interface 500 may appear to close.

Returning again to FIG. 5, an end user may select, click or otherwise actuate the On button of the On/Off button set 510 to activate the functionality of the user-created task list application. If an end user inputs their reminder and task settings but does not enable the user-created task list application by selecting the On button, then an overlay may appear to the end user asking if the end user would like to enable the application prior to closing the configuration user interface 500. In some embodiments, the default setting for the notification policy application is “Off.” If the end user wishes to disable the functionality of the notification policy application, the end user may select the Off button of the On/Off button set 510.

An end user may desire to send or receive external notifications (such as email reminders and/or reminders by text message) to indicate when tasks have been added to the user-created task list, tasks have been completed, or the user-created task list has been otherwise modified. To send an external notification, an external notification input, such as selecting or otherwise actuating the email notification box 550 may be provided by the end user. In various embodiments, when a completion input is provided, the external notification may then be transmitted. The completion input, as described above, may include selecting the OK button 560, and may cause the external notification to be transmitted when the email notification box 550 is selected. The external notification may include task completion information, which may include information relative to at least one of when the task was completed, who completed the task, and any notes the end user that completed the task would like to transmit.

Similarly, in some embodiments, the set of task completion information may also be transmitted to a reporting log when the completion input is received. The reporting log may be a user interface that includes a list of all completed task and the task completion information associated with each task, which may be advantageous for end users who like to assess the performance of the user-created task list over a period of time.

Another option that may be desirable is for the end user to access the modified user-created task list, whereby the end user may determine if a task has been added to the modified user-created task list by another end user. The user-created task list application may support this feature by transmitting the modified user-created task list via the configuration user interface 500 to the end user when a full-task input is received. The full-task input may include selecting or otherwise actuating the full task list button 570.

Furthermore, in some embodiments, a confirmation user interface may be transmitted to the end user to confirm that the additional tasks 530 (FIG. 5) have been added to the user created task list. FIG. 6 is an exemplary screenshot showing a confirmation user interface 600 associated with the user-created task list application. The exemplary screenshot 600 provides a written description of how many additional tasks have been added to the modified task list and OK button 610 allowing the end user to proceed, either to the end user's home page or to some other specified display.

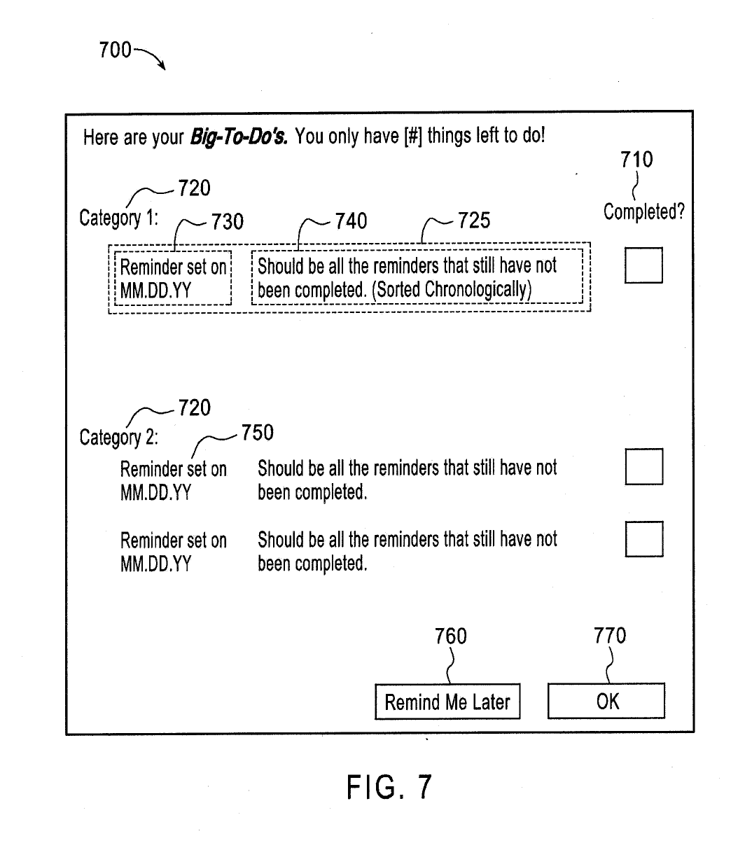

FIG. 7 is an exemplary screenshot showing an intermediary display user interface 700 associated with a user-created task list application. As seen in FIG. 7, the intermediary display user interface 700 may include a task completion column 710, categories 720, a task 725 associated with a first category, a task 750 associated with a second category, and an OK button 770. Each task 725 and 750 may be associated with an assignment date 730 corresponding to the date and time by which the task 725 needs to be completed and a written description 740 describing the nature of the task (e.g., to purchase a particular item or perform a household chore). The end user may check or otherwise select a box or button in the completion column 710 adjacent to a completed task to provide a marking input. The end user may then amend the user-created task list by providing an authorization input.

The intermediary display may also include a button allowing an end user to provide a delay input, such as a Remind Me Later button 760 as shown in the intermediary display user interface 700. When the delay input is received, the generated intermediary display may be hidden from the end user until a predetermined condition is met. The predetermined condition may be an event detectable by the user interface 700, such as the visiting of a user home page or initializing an Internet browser application.

The systems and methods described above may typically be resident in an Internet service or a DNS network. The systems and methods described may also be implemented in plug-in utilities, gateway devices, cable modems, proxy servers, set top boxes, and network interface devices.

FIG. 8 illustrates an exemplary Internet service system 800, with a DNS resolver, that may be utilized to support the above described systems and methods. A DNS resolver 810 operates in conjunction with a dynamic enforcement engine 820. The dynamic enforcement engine 820 may operate in conjunction with one or more policy modules 830 to establish any applicable polices at the DNS 810 level. The content rules are applied to received user queries, and determine the content that is delivered by the DNS network 840 through various user devices 850 to the end users 860.

The dynamic enforcement engine 820 may generate its policy engine on instructions received from one or more policy modules 830. Each policy module 830 may be constructed to provide various types and levels of services to the DNS network 840. In various embodiments, a policy module 830 may be configured to handle queries directed to subjects including, but not limited to, malicious domain redirection, user access redirection, non-existent domain redirection, and data collection or analysis.

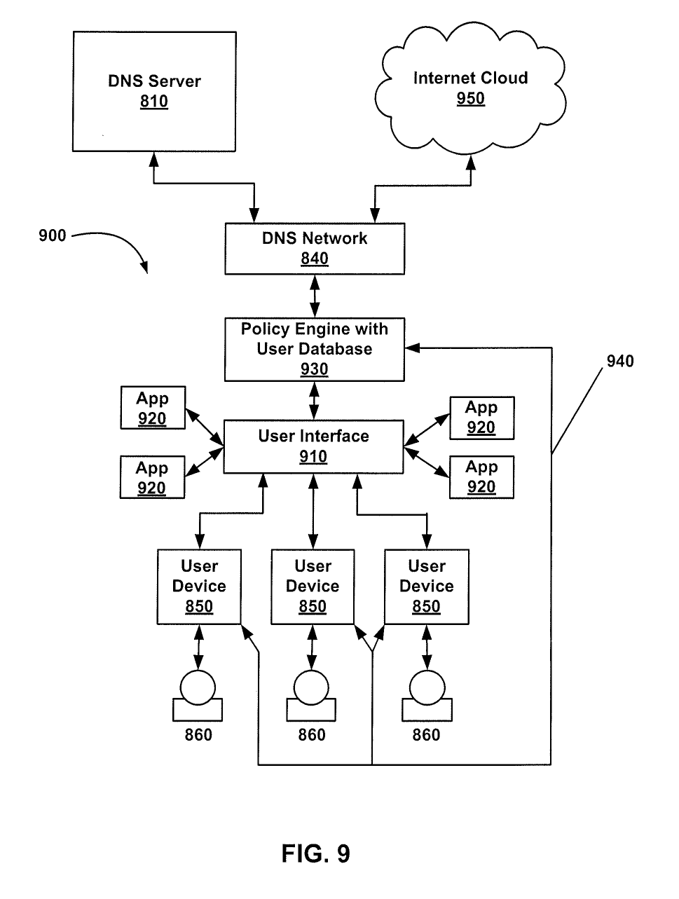

FIG. 9 shows a schematic layout of an exemplary system 900 for implementing direct and variable end user control. FIG. 9 illustrates that the system 900 may operate installed on a DNS resolver 810, or with a cloud 950 based installation.

The system 900 utilizes a user interface 910. The user interface 910 may be implemented in many embodiments. One specific implementation of the user interface 910 is as a web page.

The user interface 910 may be accessed by one or more user devices 850 operated by the users 860. The user interface 910 may be accessed though a gateway user device 850 available to the users 860. Suitable user devices 850 include but are not limited to desktops, tablet, PCs, laptops, notebooks, gaming devices, IPods, Smartphone, automobile computer systems, and Internet enabled TVs. The system 900 may also be accessed and controlled remotely by user devices 850, such as a Smartphone or other specialized Internet access device. A Smartphone may be defined as a phone with computing capability. A Smartphone may provide the user 860 with Internet access.

The user interface 910 provides a mechanism for one or more authorized users 860 to establish content policy for the Internet service. The user interface 910 operates between the user devices 850 present in the system 900 and the DNS network 840. Instructions resident on the user interface 910 therefore operate on the Internet service, by controlling at least a portion of DNS resolutions via a dynamic policy engine 930, before the service reaches the displays of the user devices 850.

The user interface 910 provides the users 860 with access to one or more policy applications 920. The user interface 910 may provide access to a selection list to at least one authorized user 860. The authorized user 860 uses the selection list or some other menu mechanism to select those policy applications 920 that the user 860 chooses to apply to the system 900. The authorized user 860 may select any number of the available policy applications for use on the system 900 at any given time. In implementations utilizing Smartphones as the user device 850, the policy applications 920 are downloaded to the device 850. The device 850 then serves as the user interface 910 to communicate directly with the dynamic policy engine 930.

The policy applications 920 may prohibit access to specific Internet content. The policy applications 920 may also limit the time of day when users or selected users 860 may access certain Internet content. The policy applications 920 may also manage and analyze duration of access to Internet content. It is important to note that the policy applications 920 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 920 may provide notifications or alerts to one or more users 860 when Internet content is accessed. The policy applications 920 may also provide notification of frequency and duration of access of designated Internet content. The policy applications 920 may also be used to observe, substitute, enable, redirect users, to reward behavior desired from the users by a system administrator, etc. The policy applications 920 may redirect users from a non-favored site to another site. The policy applications 920 may also collect and transmit data characteristic of Internet use.

Access policies supplied by the policy applications 920 may apply to all users 860 of the system 900, or the access policies may be specific to individual users or groups of users 860. The policy applications 920 may be discrete, single purpose applications.

The policy applications 920 provide the users 850 with a mechanism to take various actions relative to their Internet service feed. The policy applications 920 also allow the users 850 to establish a dynamic policy engine 930 that includes a user database. The policy engine 930 is used to enforce rules associated with each policy application associated with individual end users, not simply block various inappropriate Internet content from the Internet feed. Rather, the dynamic policy engine 930, controlled by the user interface 910 through user device(s) 850, is used to manage all aspects of the Internet experience for the users 860. In sum, the policy applications 920 may be used to configure the dynamic policy engine 930 to provide the users 860 with a mechanism to personalize the Internet experience. The policy applications 920 may be configured in combinations, and may each be separately configured.

The database in the policy engine 930 may be used to record and to notify users 860 of various data relative to Internet access. The data collected from and provided to the users 860 may include records of access of specific sites, time spent on specific sites, time of day of access, data specific to individual users, etc.

It should also be noted that following an initial setup through the user interface 910 of the policy engine 930, a direct access 940 enforcement loop may be established between the policy engine 930 and the user devices 850. Subsequent accessing of the DNS network 840 utilizing the direct access 940 decreases response time in the system 900, thereby further enhancing the Internet experience of the users 860. Configurations of policy applications 920 that are selected by one or more users 860 designated as system administrators may remain in the user database of the policy engine 930 until such time as it may be modified by the system administrators. The system administrators may define multiple policy configurations, with a combination of policy applications 920, applicable to one or more end users 860 of the system 900. Each policy application 920 may be separately configurable as well. Policy configurations may vary based upon designated times, conditional triggers, or specific requests from the users 860.

As indicated above, two discrete data flow paths may be established for the system 900. A first data path establishes a set of enforcement policies for the system 900. The first data path flows from at least one user device 850 through the user interface 910, to the policy enforcement engine 930. A second data path 940 may be utilized following the establishment of a set of policies for the system 900. The second data path 940 flows directly between the user device(s) 850 and the policy engine 930. Multiple sets of enforcement policies may be established and saved within the system 900 and implemented selectively by the users 860.

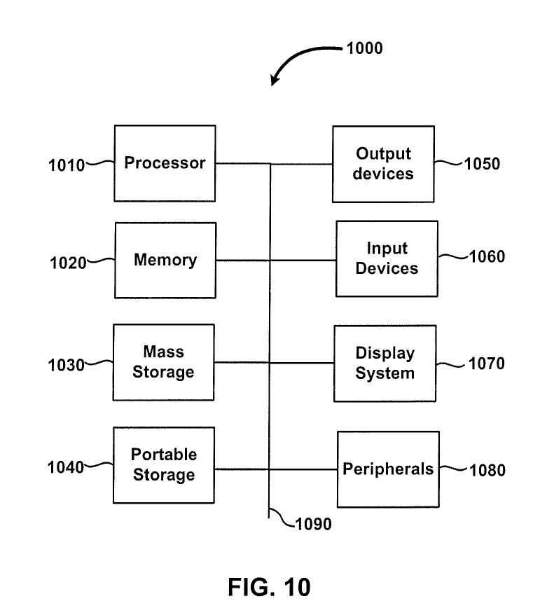

FIG. 10 illustrates an exemplary computing system 1000 that may be used to implement an embodiment of the present invention. System 1000 of FIG. 10 may be implemented in the context of user devices 850, DNS resolver 810, Internet cloud 950 and the like. The computing system 1000 of FIG. 10 includes one or more processors 1010 and memory 1020. Main memory 1020 stores, in part, instructions and data for execution by processor 1010. Main memory 1020 can store the executable code when the system 1000 is in operation. The system 1000 of FIG. 10 may further include a mass storage device 1030, portable storage medium drive(s) 1040, output devices 1050, user input devices 1060, a graphics display 1040, and other peripheral devices 1080.

The components shown in FIG. 10 are depicted as being connected via a single bus 1090. The components may be connected through one or more data transport means. Processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. Peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For instance, although this description describes the technology in the context of a DNS resolver, it will be appreciated by those skilled in the art that an Internet service provider may be utilized with this invention instead or in conjunction with a DNS server. Functionalities and method steps that are performed by a DNS server may be performed by an Internet service provider. Furthermore, one skilled in the art will appreciate that the term “Internet content” encompasses any content that may be accessed by a user device including but not limited to one or more web sites, domains, web pages, web addresses, one or more hyperlinks, URLs, any text, pictures, and/or media (such as video, audio, and any combination of audio and video) provided or displayed on a web page, and any combination thereof.

What is claimed is:

1. A method for providing reminders for a user-created task list, the method comprising:
receiving at least a portion of the user-created task list from an Internet service via a user interface between an end user and the Internet service, wherein the user-created task list includes one or more tasks organized into one or more task categories, the user-created task list being accessible by multiple network users;
generating an intermediary display, wherein the intermediary display comprises a first subset of the one or more tasks; and
transmitting the generated intermediary display via the user interface to the end user when the end user attempts to access Internet content.

2. The method of claim one 1, wherein multiple end users have editing access to the user-created task list.

3. The method of claim 1, wherein only an administrator has edit access to the user-created task list.

4. The method of claim 1, further comprising receiving a completion input that selectively amends the user-created task list to indicate that a second subset of the one or more tasks is complete, wherein the second subset of the one or more tasks is a subset of the first subset of the one or more tasks.

5. The method of claim 1, further comprising:
receiving one or more additional tasks, wherein each additional task is associated with at least one category defined for the user-created task list; and
adding the additional tasks to the user-created task list to form a modified user-created task list.

6. The method of claim 5, further comprising receiving a description associated with each additional task.

7. The method of claim 1, wherein the generated intermediary display is transmitted when the end user accesses administrator designated Internet content.

8. The method of claim 1, wherein the method further comprises transmitting the generated intermediary display when the end user accesses a home page.

9. The method of claim 8, wherein the method comprises extracting from the home page a stored browser setting file to determine a duration of a session.

10. The method of claim 8, wherein the method comprises determining the duration of a session by observing Internet usage of a specific user.

11. The method of claim 1, wherein the method further comprises generating the intermediary display when the end user accesses a specified category of Internet content.

12. The method of claim 1, wherein the task categories comprise any of a shopping category, an activities category, a household chores category, a gift wish category, a miscellaneous category, and any other user defined category.

13. The method of claim 2, wherein editing compromises updating information associated with each task.

14. The method of claim 13, wherein editing further comprises an authorization input.

15. The method of claim 5, further comprising receiving a completion input before making the modified user-created task list accessible by one or more additional end users.

16. The method of claim 5, wherein the modified user-created task list is transmitted via the user interface to the end user when a full-task input is received.

17. The method of claim 1, further comprising receiving input about a task to be performed in the future, wherein when the input is received, the generated intermediary display is hidden from the end user until a predetermined time.

18. The method of claim 1, further compromising receiving input about a task to be performed in the future, wherein when the input is received, the generated intermediary display is hidden from the end user until a predetermined task is completed.

19. The method of claim 1, wherein the one or more tasks are sorted in chronological order within the user-created task list.

20. The method of claim 1, wherein the one or more tasks are sorted in a priority order within the user-created task list.

21. The method of claim 4, further comprising transmitting an external notification comprising task completion information when the completion input is received and an external notification input is received.

22. The method of claim 4, further comprising transmitting task completion information to a reporting log when the completion input is received.

23. The method of claim 1, wherein an administrator blocks access to Internet content until completion of defined tasks.

24. The method of claim 1, wherein individual tasks are assigned to a specific end user or to groups of end users.

25. The method of claim 1, wherein the end user completing a task enters comments regarding that task.

26. The method of claim 1, wherein an administrator reviews a list of completed tasks for a defined period of time to confirm completion.

27. The method of claim 1, wherein the network is a single household.

28. The method of claim 1, wherein at least one element of the user-created task list is resident on a DNS server.

29. The method of claim 1, wherein at least one element of the user-created task list is enforced by a DNS server.

30. The method of claim 1, wherein an administrator specifies different task list policies for different locations.

31. The method of claim 1, wherein at least one element of the Internet service is resident on a user device.

32. The method of claim 1, wherein a browser setting file extracted from the home page is used by the Internet service to redirect the user to the intermediary display.

33. A system for providing reminders in a user-created task list, the system comprising:
a user interface between an end user and an Internet service that receives at least a portion of the user-created task list, wherein the user-created task list includes one or more tasks organized into one or more categories;
the Internet service storing the user-created task list; and
a processor for executing instructions stored in memory to:
generate an intermediary display, wherein the intermediary display comprises a first subset of the one or more tasks; and
transmit the generated intermediary display via the user interface to the end user.

34. The system of claim 33, wherein the processor is further configured to execute instructions stored in memory to receive a completion input that selectively amends the user-created task list to indicate that a second set of the one or more tasks is complete, wherein the second set of the one or more tasks is a subset of the first subset of the one or more tasks.

35. The system of claim 33, wherein the processor is further configured to execute instructions stored in memory to:
receive one or more additional tasks, wherein each additional task is associated with a category; and
add the additional tasks to the user-created task list to form a modified task list.

36. The system of claim 35, wherein the processor is further configured to execute instructions stored in memory to receive a description associated with each additional task.

37. The system of claim 33, wherein the processor is further configured to execute instructions stored in memory to transmit the generated intermediary display when the end user accesses an end user home page and to extract the end user home page from a stored browser setting file.

38. The system of claim 33, wherein the one or more categories comprise a shopping category, an activities category, a household chores category, a gift wish category and a miscellaneous category.

39. The system of claim 33, wherein the completion input comprises a marking input associated with each task within the second set of the one or more tasks.

40. The system of claim 39, wherein the completion input further comprises an authorization input.

41. The system of claim 33, wherein the transmitted intermediary display further comprises a description of a set of one or more tasks, the one or more tasks having been completed before transmission of intermediary display.

42. The system of claim 34, wherein the processor is further configured to execute instructions stored in memory to receive a confirmation input before making the modified task list accessible by one or more additional end users.

43. The system of claim 33, wherein the modified task list is transmitted via the user interface to the end user when a full-task input is received.

44. The system of claim 33, wherein the processor is further configured to execute instructions stored in memory to receive a delay input, wherein when the delay input is received, the generated intermediary display is hidden from the end user until a predetermined condition is met.

45. The system of claim 33, wherein the one or more tasks are sorted in chronological order within the user-created task list.

46. The system of claim 34, wherein the processor is further configured to execute instructions stored in memory to transmit an external notification comprising task completion information when the completion input is received and an external notification input is received.

47. The system of claim 35, wherein the processor is further configured to execute instructions stored in memory to transmit task completion information to a reporting log when the completion input is received.

48. The system of claim 33, wherein at least one element of the user-created task list is resident on a DNS server.

49. The system of claim 33, wherein at least on element of the user-created task list is enforced by a DNS server.

50. The system of claim 33 wherein the intermediary display is displayed to all end users.

51. A non-transitory computer-readable storage medium having embodied thereon a program, the program executable by a processor in a computing device to perform a method for providing reminders, the method comprising:
receiving at least a portion of a user-created task list from an Internet service via a user interface between an end user and the Internet service, wherein the user-created task list includes one or more tasks organized into one or more categories;
generating an intermediary display, wherein the intermediary display comprises a first subset of the one or more tasks; and
transmitting the generated intermediary display via the user interface to the end user.

52. A method for providing reminders for a user-created task list, the method comprising:
receiving at least a portion of the user-created task list from an Internet service via a user interface between an end user and a DNS server, wherein the user-created task list includes one or more tasks organized into one or more categories, the user-created task list being accessible by multiple network users;
generating an intermediary display, wherein the intermediary display comprises a first subset of the one or more tasks; and
transmitting via the DNS server the generated intermediary display via the user interface to the end user when the end user attempts to access Internet content.

53. The method of claim 52, wherein the intermediary display is displayed to all end users, and an opt out provision is not available.

54. The method of claim 52, wherein all end users have edit access to the user-created task list.

55. The method of claim 52, wherein only an administrator has edit access to the user-created task list.

56. The method of claim 52, further comprising receiving a completion input that selectively amends the user-created task list to indicate that a second subset of the one or more tasks is complete, wherein the second subset of the one or more tasks is a subset of the first subset of the one or more tasks.

57. The method of claim 56, wherein the completion input is received from the user interface.

58. The method of claim 56, wherein the completion input is received from the intermediary display via the user device.

59. The method of claim 52, wherein an administrator specifies different task list policies for different locations.

60. The method of claim 52, further comprising:
receiving one or more additional tasks, wherein each additional task is associated with at least one category defined for the user-created task list; and
adding the additional tasks to the task list to form a modified task list.

61. The method of claim 52, further comprising receiving a description associated with each additional task.

62. The method of claim 52, wherein the generated intermediary display is transmitted via the DNS server when the end user accesses administrator designated Internet content.

63. The method of claim 52, wherein the method further comprises transmitting the generated intermediary display via the DNS server the first time during a user session that the end user accesses Internet content.

64. The method of claim 63, wherein the method comprises extracting from the home page a stored browser setting file to determine a duration of a session.

65. The method of claim 64, wherein the extracted setting is used by the Internet service to redirect the end user to the intermediary display.

66. The method of claim 52, wherein the method comprises determining the duration of a session for an end user by observing Internet usage of a specific user via the DNS server.

67. The method of claim 52, wherein the method further comprises generating the intermediary display via the DNS server when the end user accesses a specified category of Internet content.

68. The method of claim 52, wherein the task categories comprise any of a shopping category, an activities category, a household chores category, a gift wish category, a miscellaneous category, and any other user defined category.

69. The method of claim 52, wherein editing comprises updating information associated with each task.

70. The method of claim 52, wherein the editing comprises an authorization input.

71. The method of claim 52, further comprising receiving a completion input before making the modified task list accessible by one or more additional end users.

72. The method of claim 52, wherein the modified task list is transmitted via the DNS server to the end user when a full-task input is received.

73. The method of claim 52, further comprising receiving input about a task to be performed in the future, wherein when the input is received, the generated intermediary display is hidden from the end user until a predetermined time.

74. The method of claim 52, further compromising receiving input about a task to be performed in the future, wherein when the input is received, the generated intermediary display is hidden from the end user until a predetermined task is completed.

75. The method of claim 52, wherein the one or more tasks are sorted in chronological order within the user-created task list.

76. The method of claim 52, wherein the one or more tasks are sorted in a priority order within the user-created task list.

77. The method of claim 52, further comprising transmitting an external notification comprising task completion information when the completion input is received and a request for external notification input is received.

78. The method of claim 52, wherein individual tasks are assigned to a specific end user or to groups of end users.

79. The method of claim 52, wherein the network is a home network.

80. The method of claim 52, wherein the DNS server blocks access to administrator defined Internet content until completion of defined tasks.

81. A system for providing reminders in a user-created task list, the system comprising:
a user interface between an end user and a DNS server that receives at least a portion of the user-created task list, wherein the user-created task list includes one or more tasks organized into one or more categories;
the DNS server storing the user-created task list; and
a processor for executing instructions stored in memory to:
generate an intermediary display, wherein the intermediary display comprises a first subset of the one or more tasks; and
transmit the generated intermediary display via the user interface to the end user.

82. The system of claim 81, wherein the processor is further configured to execute instructions stored in memory to receive a completion input that selectively amends the user-created task list to indicate that a second set of the one or more tasks is complete, wherein the second set of the one or more tasks is a subset of the first subset of the one or more tasks.

83. The system of claim 82, wherein the processor is further configured to execute instructions stored in memory to:
receive one or more additional tasks, wherein each additional task is associated with a category; and
add the additional tasks to the user-created task list to form a modified task list.

84. The system of claim 83, wherein the processor is further configured to execute instructions stored in memory to receive a description associated with each additional task.

85. The system of claim 81, wherein the processor is further configured to execute instructions stored in memory to transmit the generated intermediary display when the end user accesses an end user home page and to extract the end user home page from a stored browser setting file.

86. The system of claim 81, wherein the one or more categories comprise a shopping category, an activities category, a household chores category, a gift wish category and a miscellaneous category.

87. The system of claim 81, wherein the completion input comprises a marking input associated with each task within the second set of the one or more tasks.

88. The system of claim 87, wherein the completion input further comprises an authorization input.

89. The system of claim 81, wherein the transmitted intermediary display further comprises a description of a set of one or more tasks, the one or more tasks having been completed before transmission of intermediary display.

90. The system of claim 81, wherein the processor is further configured to execute instructions stored in memory to receive a confirmation input before making the modified task list accessible by one or more additional end users.

91. The system of claim 83, wherein the modified task list is transmitted via the user interface to the end user when a full-task input is received.

92. The system of claim 81, wherein the processor is further configured to execute instructions stored in memory to receive a delay input, wherein when the delay input is received, the generated intermediary display is hidden from the end user until a predetermined condition is met.

93. The system of claim 81, wherein the one or more tasks are sorted in chronological order within the user-created task list.

94. The system of claim 81, wherein the processor is further configured to execute instructions stored in memory to transmit an external notification comprising task completion information when the completion input is received and an external notification input is received.

95. The system of claim 81, wherein the processor is further configured to execute instructions stored in memory to transmit task completion information to a reporting log when the completion input is received.
